(19) United States
(12) Patent Application Publication
(10) Pub. No.: US 2008/0216687 A1
(43) Pub. Date: Sep. 11, 2008

(54) PRINTING UNIT OF A WEB-FED PRINTING PRESS

(75) Inventor: Wolfgang Kaeser, Mertingen (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 12/043,049

(22) Filed: Mar. 5, 2008

(30) Foreign Application Priority Data
Mar. 6, 2007 (DE) 10 2007 010 762.7

(51) Int. Cl. B41F 5/04

(52) U.S. Cl. 101/219

(57) ABSTRACT

A printing unit of a web-fed printing press having several printing couples is disclosed. Each printing couple includes a plate cylinder, a transfer cylinder, an inking system as well as, if applicable, a dampening system. Two printing couples respectively arranged vertically one above the other form a printing couple group and are assigned a common safety device in order to cover hazardous areas on the respective printing couple group. The safety device is translatorily displaceable at least in sections in order to free up or block access to the printing couples of the printing couple group.

This application claims the priority of German Patent Document No. 10 2007 010 762.7, filed Mar. 6, 2007, the disclosure of which is expressly incorporated by reference herein.

### BACKGROUND AND SUMMARY OF THE INVENTION

The invention relates to a printing unit of a web-fed printing press.

Printing units of web-fed printing presses that are known from practice have several printing couples, wherein each printing couple has a transfer cylinder, a plate cylinder, an inking system as well as, if applicable, a dampening system. Plate cylinders are also designated as engraving cylinders and transfer cylinders are also called blanket cylinders. In addition, these types of satellite printing units may feature impression cylinders, wherein an impression cylinder can cooperate with one or more transfer cylinders of different printing couples. The impression cylinders are also designated as satellite cylinders, which is why printing units with at least one impression cylinder are also called satellite printing units. In addition to satellite printing units that have impression cylinders, printing units that do not have any impression cylinders are known, wherein, in the case of printing units without impression cylinders, the transfer cylinders of two printing couples roll off one another.

A printing unit of a web-fed printing press is known from German Patent Document No. DE 196 42 561 C5, wherein each printing couple of the printing unit is assigned a separate protective covering in order to cover hazardous areas on the respective printing couple and thereby block access to the respective printing couple. For example, to free up access to a printing couple in order perform servicing work, for example, according to the prior art, the respective protective covering can be swiveled around a swivel axis. Assigning individual protective coverings to each printing couple of a printing unit is structurally involved and expensive. In addition, protective covers that can swivel require a relatively large amount of construction space.

Starting herefrom, the present invention is based on the objective of creating a novel printing unit of a web-fed printing press.

According to the invention, two printing couples respectively arranged one above the other, which form a printing couple group, are respectively assigned a common safety device, in order to cover hazardous areas on the respective printing couple group, wherein the safety device assigned to a printing couple group is translatorily displaceable at least in sections in order to free up or block access to printing couples of the printing couple group.

In terms of the inventive printing unit, two printing couples arranged vertically one above the other, which form a printing couple group, are assigned a common safety device, which is translatorily displaceable at least in sections in order to free up or block access to the printing couples of the printing couple group. The number of required safety devices can be reduced with the present invention. This is advantageous for reasons related to costs. In addition, translatorily displaceable safety devices require less construction space than the swiveling safety devices that are known from the prior art.

The safety device assigned to a printing couple group preferably has several plate-like segments, wherein the plate-like segments can be displaced relative to one another in a telescoping manner in the vertical direction perpendicular to a surface normal of the segments.

Preferred developments of the invention are yielded from the following description. Without being limited hereto, one exemplary embodiment of the invention is explained in greater detail on the basis of the drawings.

### BRIEF DESCRIPTION OF THE DRAWINGS

FIG. 1 is a side view of an inventive printing unit of a web-fed printing press.

FIG. 2 is a front view of the printing unit from FIG. 1.

### DETAILED DESCRIPTION OF THE DRAWINGS

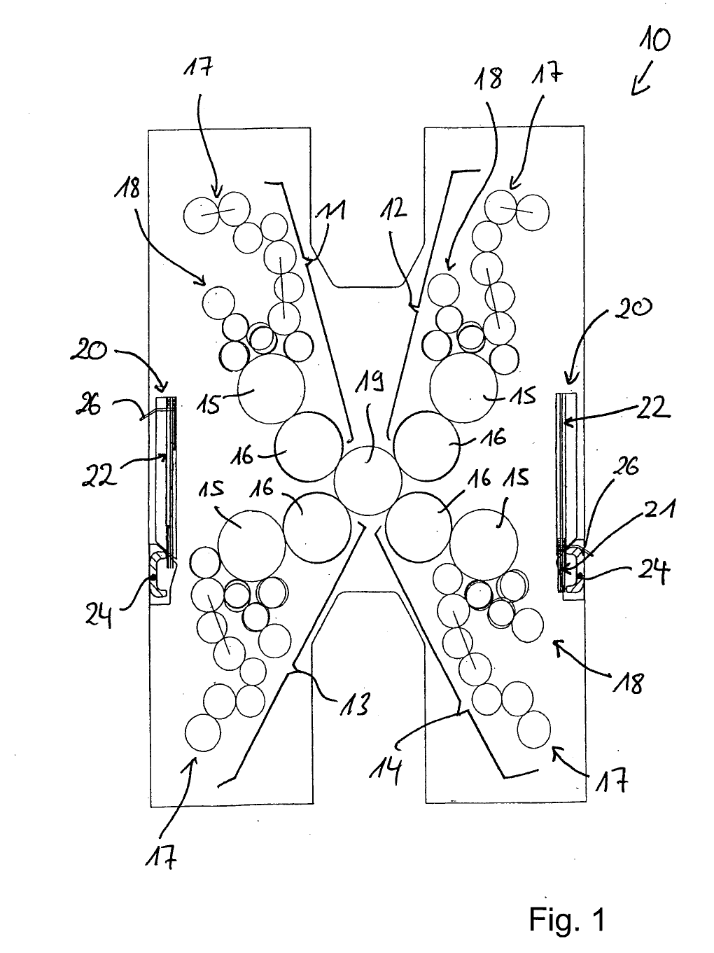

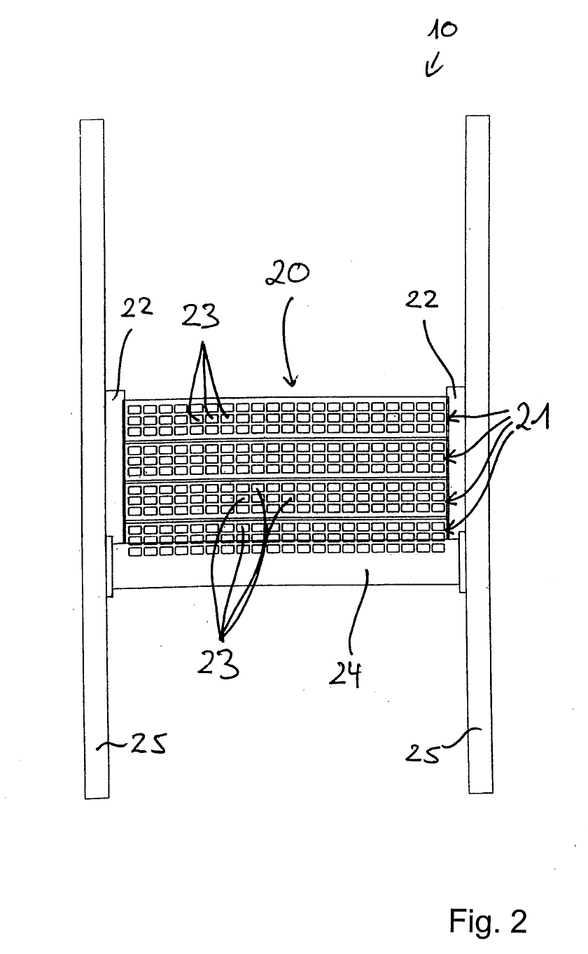

FIGS. 1 and 2 show different views of an inventive printing unit 10 of a web-fed rotary printing press, whereby the printing unit 10 in FIG. 1 is comprised of four printing couples 11, 12, 13 and 14. Each of the printing couples 11 through 14 includes a plate cylinder 15, a transfer cylinder 16, an inking system 17 as well as a dampening system 18, whereby the transfer cylinders 16 of all printing couples 11 through 14 roll off an impression cylinder 19. The printing unit 10 in FIG. 1 is therefore designed as a nine-cylinder satellite printing unit.

Two printing couples 11, 13 as well as 12, 14, respectively arranged vertically one above the other, respectively form a printing couple group, wherein each printing couple group made up of two printing couples 11, 13 and 12, 14 positioned one above the other are respectively assigned a common safety device 20. This safety device 20 makes it possible to safeguard hazardous areas of the printing couples 11, 13 and 12, 14 arranged on top of one another, in that the respective safety device 20 covers the hazardous areas.

In this case, the safety device 20 assigned to a printing couple group made up of printing couples 11, 13 or 12, 14 arranged one above the other is translatorily or linearly displaceable in this case at least in sections in order to free up or block access to the printing couple group.

In FIG. 1, the safety device 20 assigned to the printing couples 11, 13 forming the left printing couple group covers the cylinders 15, 16 of the printing couples 11, 12. On the other hand, the safety device 20 assigned to the printing couples 12, 14 forming the right printing couple frees up the cylinders 15, 16 of these printing couples 12, 14.

In the exemplary embodiment in FIGS. 1 and 2, each of the safety devices 20 is made up of several plate-like segments 21, whereby, according to FIG. 2 the safety device 20 is comprised of four plate-like segments 21. The plate-like segments can be displaced relative to one another, and namely perpendicularly to a surface normal of the plate-like segments 21. In this case according to FIG. 2, the plate-like segments 21 can be displaced relative to one another in a telescoping manner.

All segments 21 of the safety device 20 are guided laterally into linear guides 22 in order to displace the individual segments 21 up or down in the vertical direction. In FIG. 2 all the segments 21 of the safety device 20 are extended and cover a hazardous area on the respective printing couple group. Openings 23 have been made in the segments 21 in order to make it easier to view the cylinders of the respective printing couple group.

To free up access to the cylinders 15, 16 of the respective printing couple group, the segments 21 of the safety device 20 are translatorily displaceable relative to one another in the vertical direction in such a way that all segments 21 are positioned in succession and can be brought into overlap with a crossbar 24 on which the linear guides 22 are fastened. The crossbar 24 extends between two vertical supports 25 of a frame of the printing unit 10.

To manually actuate the safety device 20, an operating device 26 is assigned to one segment 21 of the safety device 20. The operating device 26 is an actuating handle.

When the safety device 20 frees up access to the cylinders 15, 16 of a printing couple group made of up printing couples arranged one above the other, the operating device 26 ends up adjacent to the crossbar 24.

In the exemplary embodiment in FIGS. 1 and 2, all segments 21 of the safety device 20 for freeing up access to the cylinders 15, 16 of printing couples arranged one above the other are translatorily displaceable in one direction downwardly. In contrast to this, it is also possible for a first group of segments to be translatorily displaceable downwardly and a second group of segments to be translatorily displaceable upwardly. It is just as possible for a safety device to be made available from segments that are translatorily displaceable in a horizontal direction as well as in a telescoping manner.

In the case of the inventive printing unit, hazardous locations between cylinders of printing couples, which are arranged one above the other and that form a printing couple group, are safeguarded by a common safety device. The safety device is translatorily displaceable at least in sections, whereby the safety device preferably comprises segments that can be displaced relative to one another in a telescoping manner. The segments are preferably assigned catches in order to guarantee that the segments carry each other along when the segments are being extended or retracted.

Each safety device is preferably assigned a safety switch, whereby the safety switch automatically opens every time the safety device is opened, so that when the safety device is opened the corresponding printing couples of the printing unit can only be operated in an inching mode.

### LIST OF REFERENCE NUMERALS

10 Printing unit
11 Printing couple
12 Printing couple
13 Printing couple
14 Printing couple
15 Plate cylinder
16 Transfer cylinder
17 Inking system
18 Dampening system
19 Impression cylinder
20 Safety device
21 Segment
22 Linear guide
23 Opening
24 Crossbar
25 Support
26 Operating device

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A printing unit of a web-fed printing press having several printing couples, wherein each printing couple is comprised of a plate cylinder, a transfer cylinder, an inking system as well as, if applicable, a dampening system, and wherein two printing couples respectively arranged vertically one above the other form a printing couple group and are assigned a common safety device, wherein the safety device is translatorily displaceable at least in sections in order to free up and block access to the printing couples of the printing couple group.

2. The printing unit according to claim 1, wherein the safety device has several plate-like segments, wherein the plate-like segments are displaceable perpendicularly to a surface normal of the segments.

3. The printing unit according to claim 2, wherein the segments are displaceable relative to one another in a telescoping manner.

4. The printing unit according to claim 2, wherein the segments are displaceable relative to one another in a vertical direction.

5. The printing unit according to claim 2, wherein the segments are displaceable relative to one another in a horizontal direction.

6. The printing unit according to claim 2, wherein the segments are guided laterally into linear guides and wherein the linear guides are positioned on a frame of the printing unit.

7. A printing unit of a web-fed printing press, comprising:
a first printing couple arranged above a second printing couple and forming a printing couple group; and
a safety device, wherein the safety device is moveable between a first position where the safety device blocks access to the first and second printing couples of the printing couple group and a second position where the safety device permits access to the first and second printing couples of the printing couple group.

8. The printing unit according to claim 7, wherein the safety device includes a plurality of segments and wherein at least one of the plurality of segments is translatorily displaced to move the safety device to the first and second positions.

9. The printing unit according to claim 7, wherein the first and second printing couples each include a plate cylinder, a transfer cylinder, an inking system, and a dampening system.

10. The printing unit according to claim 9, wherein when the safety device is in the first position, the safety device blocks access to the respective plate cylinders and transfer cylinders of the first and second printing couples and wherein when the safety device is in the second position, the safety device permits access to the respective plate cylinders and transfer cylinders of the first and second printing couples.

11. The printing unit according to claim 8, further comprising a support frame and a linear guide and wherein the at least one of the plurality of segments is translatorily moveable in the linear guide.
